(19) United States
(12) Patent Application Publication
(10) Pub. No.: US 2025/0001536 A1
(43) Pub. Date: Jan. 2, 2025

(54) TOOL POSITIONING APPARATUS

(71) Applicant: Rivian IP Holdings, LLC, Irvine, CA (US)

(72) Inventor: Lucas MAZNIO, Costa Mesa, CA (US)

(21) Appl. No.: 18/344,796

(22) Filed: Jun. 29, 2023

(51) Int. Cl. B23Q 3/18; B23B 35/00

(52) U.S. Cl. CPC B23Q 3/18; B23B 35/00

(57) ABSTRACT

The present disclosure relates to tool positioning apparatus, and related components and methods, for vehicle manufacturing and servicing operations. In one or more embodiments, an apparatus for positioning a tool includes a shaft housing, and a threaded shaft extending into the shaft housing. The apparatus includes a rotatable actuator disposed about an outer section of the threaded shaft that is disposed outwardly of the shaft housing. The apparatus includes a holder frame disposed about the threaded shaft, and a spring positioned between the rotatable actuator and the holder frame.

### INTRODUCTION

Vehicle manufacturing and servicing commonly involves tool operations (e.g., drilling) in difficult-to-reach locations of the vehicle. Such operations often require a significant amount of force to be applied to a tool for a lengthy period of time, which may quickly fatigue a vehicle technician and/or result in accelerated wear and tear of a tool and/or a vehicle component.

### SUMMARY

The present disclosure relates to tool positioning apparatus, and related components and methods, for vehicle manufacturing and servicing operations.

In one or more embodiments, an apparatus for positioning a tool includes a shaft housing, and a threaded shaft extending into the shaft housing. The apparatus includes a rotatable actuator disposed about an outer section of the threaded shaft that is disposed outwardly of the shaft housing. The apparatus includes a holder frame disposed about the threaded shaft, and a spring positioned between the rotatable actuator and the holder frame.

In one or more embodiments, an apparatus for positioning a tool includes a shaft housing, a threaded shaft extending into the shaft housing, and a rotatable actuator disposed about an outer section of the threaded shaft that is disposed outwardly of the shaft housing. The threaded shaft is threaded into the rotatable actuator. The apparatus includes a holder frame disposed about the threaded shaft, and a pivotable actuator coupled to the shaft housing.

In one or more embodiments, a method of positioning a tool for a vehicle frame includes mounting the tool to a holder frame of an apparatus. The method includes laterally moving the apparatus under the vehicle frame. The vehicle frame includes a shaft housing, and a threaded shaft extending into the shaft housing. The holder frame is disposed about the threaded shaft. The method includes turning a rotatable actuator disposed about the threaded shaft to drive the threaded shaft and the holder frame upwards toward the vehicle frame. The method includes powering the tool, and pivoting a pivotable actuator to further drive the threaded shaft and the holder frame upwards toward the vehicle frame.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting in scope, and may admit to other equally effective embodiments.

FIG. 1 is a schematic partial axonometric view of an apparatus for positioning a tool mounted to the apparatus, according to one or more embodiments.

FIG. 2 is a schematic partial enlarged axonometric view of the holder frame shown in FIG. 1, according to one or more embodiments.

FIG. 3 is a schematic partial enlarged axonometric view of a first side of the pivotable actuator shown in FIG. 1, according to one or more embodiments.

FIG. 4 is a schematic partial enlarged axonometric view of a second side of the pivotable actuator shown in FIG. 1, according to one or more embodiments.

FIG. 5 is a schematic side cross sectional view of the apparatus shown in FIG. 1, according to one or more embodiments.

FIG. 6A is a schematic enlarged cross sectional view of an upper section of the apparatus shown in FIG. 1, according to one or more embodiments.

FIG. 6B is a schematic enlarged view of the upper section shown in FIG. 6A, after turning of the rotatable actuator, according to one or more embodiments.

FIG. 6C is a schematic enlarged view of the upper section shown in FIG. 6B, after downward movement of the holder frame, according to one or more embodiments.

FIG. 8 is a schematic enlarged cross sectional view of a lower section of the apparatus shown in FIG. 1, according to one or more embodiments.

FIG. 9 is a schematic partial side view of a user operating the apparatus for to position the tool in relation to a vehicle according to one or more embodiments.

FIG. 10 is a flowchart of a method of positioning a tool in relation to a vehicle, according to one or more embodiments.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure relates to tool positioning apparatus, and related components and methods, for vehicle manufacturing and servicing operations. In one or more embodiments, an apparatus for positioning a tool (e.g., a drill) includes a shaft housing, and a threaded shaft extending into the shaft housing. The apparatus further includes a rotatable actuator disposed about an outer section of the threaded shaft that is disposed outwardly of the shaft housing. The apparatus also includes a holder frame disposed about the threaded shaft, and a spring positioned between the rotatable actuator and the holder frame.

The apparatus can be laterally moved (e.g., wheeled) under a vehicle to vertically operate a tool (such as to vertically drill openings into a frame of the vehicle) from below the vehicle. The rotatable actuator can be used to vertically move the tool closer to the vehicle. The pivotable actuator can be used (while powering the tool) to vertically move a tool component toward the vehicle (such as vertically moving a drill bit into the frame to drill one an opening in the frame). The pivoting of the pivotable actuator compresses the spring. The compression of the spring biases the tool (e.g., the drill bit of the tool) toward the vehicle (such as into the frame) in a manner that reduces or eliminates the likelihood of excessive wear and/or breakage of the tool (e.g., wear and/or breakage of a drill bit).

In one or more embodiments, the frame of the vehicle is a frame of an automotive vehicle, such as an electric vehicle (e.g., a service van). In one or more embodiments, the frame includes one or more beams (e.g., hollow square beams) composed of steel, aluminum, or other alloys.

The disclosure contemplates that terms used herein such as “couples,” “coupling,” “couple,” and “coupled” may include but are not limited to welding, fusing, melting together, interference fitting, and/or fastening such as by using bolts, threaded connections, pins, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links, blocks, and/or frames.

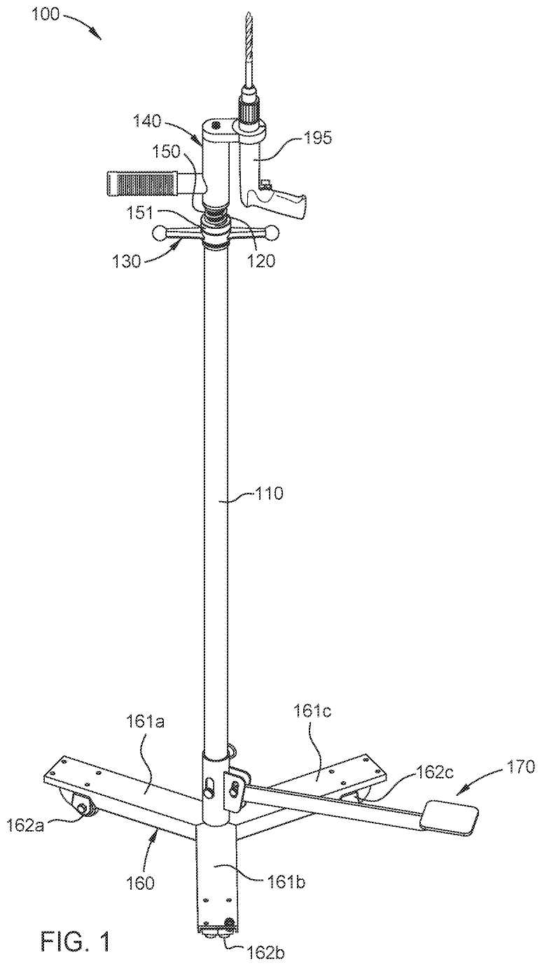

FIG. 1 is a schematic partial axonometric view of an apparatus 100 for positioning a tool 195 mounted to the apparatus 100, according to one or more embodiments. In the implementation shown in FIG. 1, the tool 195 is a drill. The present disclosure contemplates that other tools (including but not limited to socket drives and/or wrench tools) can be mounted to the apparatus 100 and positioned using the apparatus 100.

The apparatus 100 includes a shaft housing 110, a threaded shaft 120 extending into the shaft housing 110, and a rotatable actuator 130. The apparatus 100 further includes a holder frame 140 disposed about the threaded shaft 120, and a spring 150 positioned between the rotatable actuator 130 and the holder frame 140. The apparatus 100 also includes an outer shoulder 151 coupled to the threaded shaft 120 and positioned between the spring 150 and the rotatable actuator 130.

In one or more embodiments, the apparatus 100 may include a base frame 160, and the shaft housing 110 may be mounted to the base frame 160. The base frame 160 may include a plurality of base arms 161a-161c supported by a plurality of wheels 162a-162c. The wheels 162a-162c of the base frame 160 enable the apparatus 100 to be laterally moved (e.g., wheeled) under and/or out from a vehicle. The apparatus 100 further includes a pivotable actuator 170 coupled to the shaft housing 110.

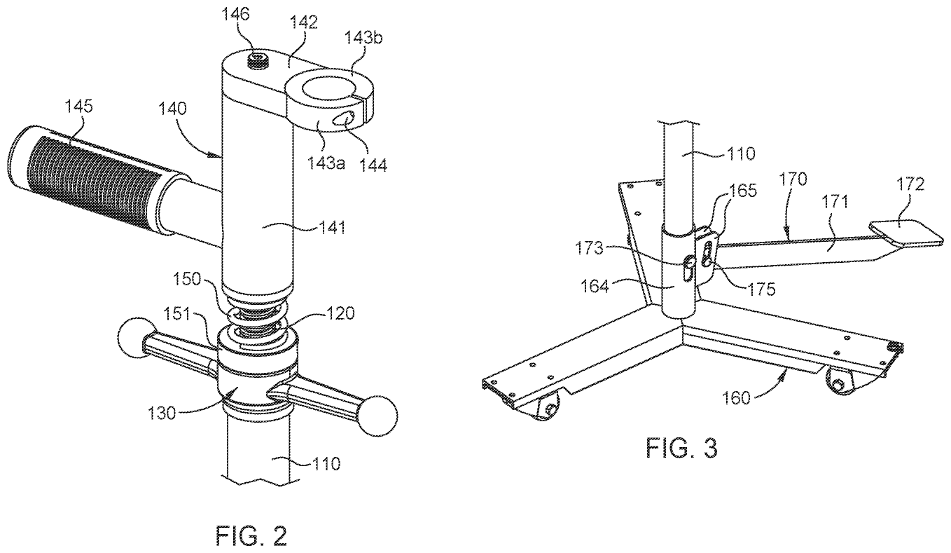

FIG. 2 is a schematic partial enlarged axonometric view of the holder frame 140 shown in FIG. 1, according to one or more embodiments. The holder frame 140 includes a sleeve 141, a flange 142 extending relative to the sleeve 141, and one or more clamp arms 143a, 143b coupled to the flange 142. In one or more embodiments, the flange 142 is a cap couple to the sleeve 141. The spring 150 is positioned between the rotatable actuator 130 and the sleeve 141 of the holder frame 140. The one or more clamp arms 143a, 143b are configured to couple to the tool 195 (e.g., a drill) shown in FIG. 1. In one or more embodiments, one or more fasteners can be extended through openings 144 formed in the one or more clamp arms 143a, 143b and can be tightened to bias the one or more clamp arms 143a, 143b to grip and support the tool 195. In one or more embodiments, two clamp arms 143a, 143b are included (as shown in FIG. 2). The holder frame 140 includes a handle 145 extending relative to the sleeve 141, and a fastener 146 extending through the flange 142 and coupled to the threaded shaft 120.

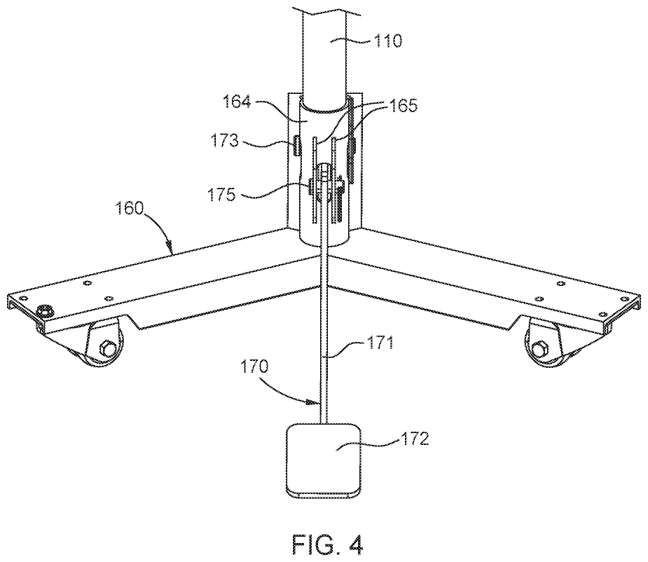

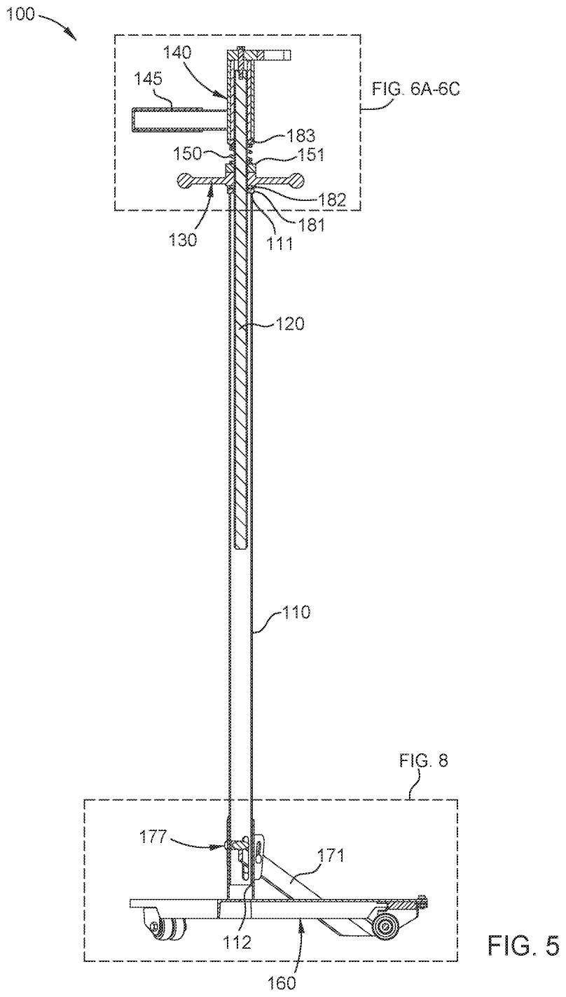

FIG. 3 is a schematic partial enlarged axonometric view of a first side of the pivotable actuator 170 shown in FIG. 1, according to one or more embodiments. FIG. 4 is a schematic partial enlarged axonometric view of a second side of the pivotable actuator 170 shown in FIG. 1, according to one or more embodiments. The pivotable actuator 170 may include a lever arm 171 and a foot platform 172. A first fastener 173 (e.g., a first traveling pin) may extend through an outer sleeve 164 of the base frame 160 and through the shaft housing 110. A second fastener 175 (e.g., a second traveling pin) may extend through the lever arm 171 and through a plurality of flanges 165 coupled to the outer sleeve 164.

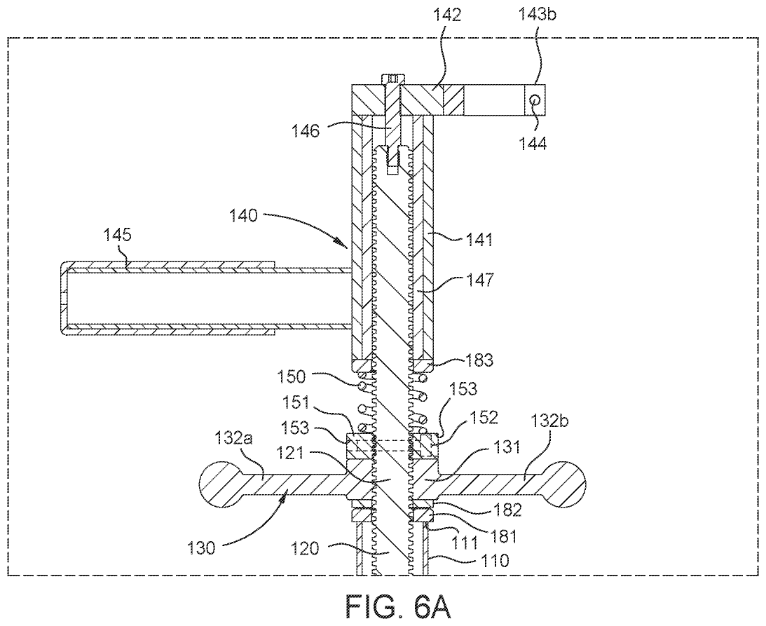

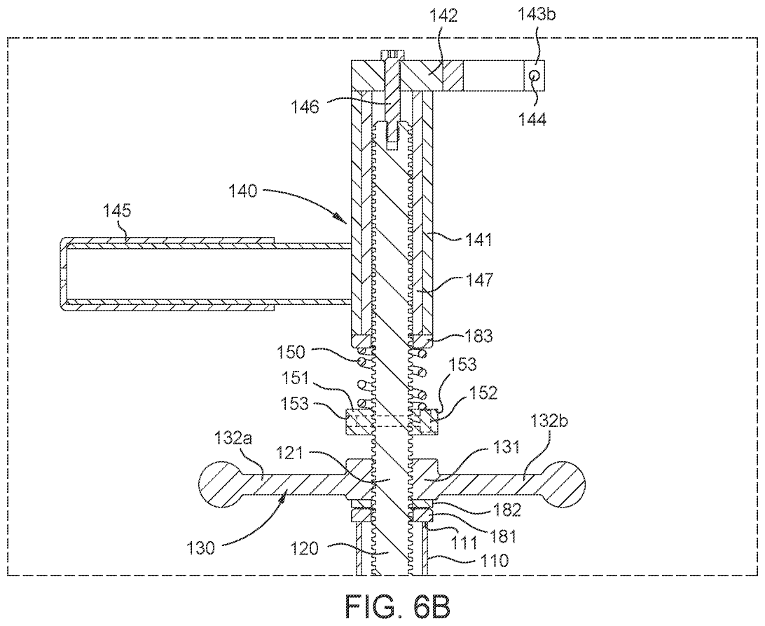

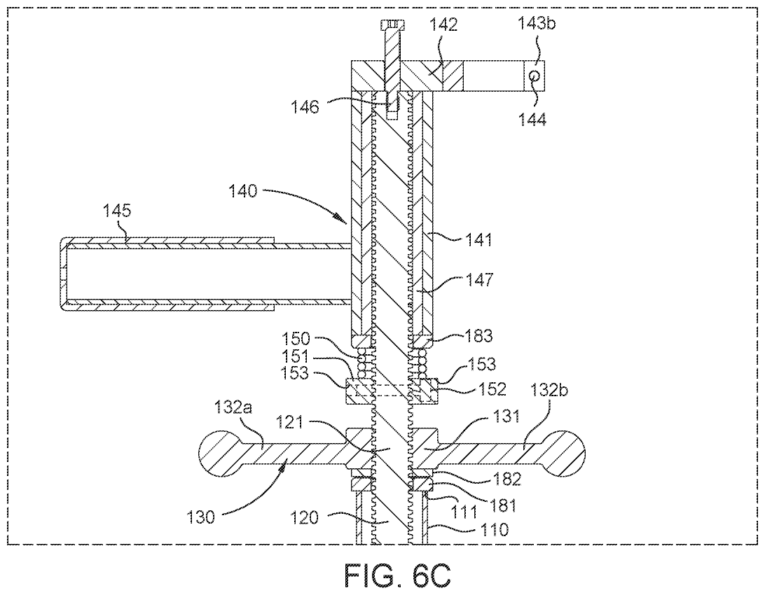

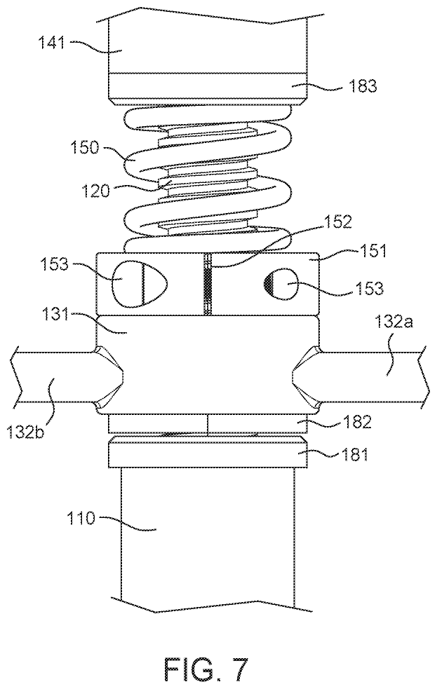

FIG. 5 is a schematic side cross sectional view of the apparatus 100 shown in FIG. 1, according to one or more embodiments. FIG. 6A is a schematic enlarged view of an upper section of the side cross sectional view of the apparatus 100 shown in FIG. 5, according to one or more embodiments. The rotatable actuator 130 is disposed about an outer section 121 (e.g., of an outer face) of the threaded shaft 120 that is disposed outwardly of the shaft housing 110.

The outer shoulder 151 may include one or more ring segments and one or more fasteners 152 that can be extended through openings 153 formed in the one or more ring segments and tightened to clamp the outer shoulder 151 to the threaded shaft 120. In one or more embodiments, and as shown in FIG. 6A and FIG. 7, the outer shoulder 151 includes a single ring segment in the form of a collar. In one or more embodiments, the outer shoulder 151 is clamped in place relative to the threaded shaft 120 such that the rotatable actuator 130 is configured to rotate relative to the outer shoulder 151.

The rotatable actuator 130 includes a ring section 131 encircling the threaded shaft 120, and at least one arm 132a, 132b (two are shown in FIG. 6A) extending outwardly relative to the ring section 131. The threaded shaft 120 is threaded into the rotatable actuator 130 to threadably couple the threaded shaft 120 to the rotatable actuator 130. The rotatable actuator 130 is positioned adjacent a first end 111 of the shaft housing 110. In one or more embodiments, a washer 181 and/or a bearing 182 are positioned between the rotatable actuator 130 and the first end 111 of the shaft housing 110. The rotatable actuator 130 can abut against the bearing 182. The washer 181 can abut against the first end 111 of the shaft housing 110. In one or more embodiments, the washer 181 and/or the bearing 182 is omitted. In such an embodiment, the rotatable actuator 130 can abut against the washer 181 or the first end 111 of the shaft housing 110. In one or more embodiments, a washer 183 is positioned between the spring 150 and the sleeve 141 of the holder frame 140. In one or more embodiments, the spring 150 abuts against the outer shoulder 151 and against the washer 183. In one or more embodiments, the washer 183 can be omitted. In such an embodiment, the spring 150 can abut against the sleeve 141.

In one or more embodiments, a non-metallic sleeve 147 is disposed within the sleeve 141 of the holder frame 140 and positioned between the sleeve 141 and the threaded shaft 120. The non-metallic sleeve 147 may be formed of a polymeric material, for example, a fluoropolymer such as polytetrafluoroethylene (PTFE). Other materials are contemplated for the non-metallic sleeve 147.

FIG. 6B is a schematic enlarged view of the upper section shown in FIG. 6A, after turning of the rotatable actuator 130, according to one or more embodiments. As shown, the rotatable actuator 130 has been turned (e.g., rotated) to drive the threaded shaft 120 upwardly using the threaded interface between the rotatable actuator 130 and the outer section 121 of the threaded shaft 120. The upward linear movement of the threaded shaft 120 linearly moves the outer shoulder 151, the spring 150, the holder frame 140, and the fastener 146 upwardly. In one or more embodiments, the upward movement of the outer shoulder 151 and the threaded shaft 120 exposes at least part of the threaded shaft 120 between the outer shoulder 151 and the rotatable actuator 130.

FIG. 6C is a schematic enlarged view of the upper section shown in FIG. 6B, after downward movement of the holder frame 140, according to one or more embodiments. As shown, the downward linear movement of the holder frame 140 moves the holder frame 140 relative to the threaded shaft 120, the fastener 146, and the outer shoulder 151. The downward linear movement of the holder frame 140 compresses the spring 150 against the outer shoulder 151, and the compressed spring 150 can bias the holder frame 140 upwardly. As described below, downward linear movement of the holder frame 140 can be caused, for example, by an opposing force on the holder frame 140 from the tool 195 abutting against a vehicle frame when a user depresses the foot platform 172 to move the tool 195 up towards a vehicle and, when the tool 195 contacts the vehicle, the spring 150 compresses when further force is applied to the foot platform 172.

FIG. 7 is a schematic backside view of the outer shoulder 151 shown in FIGS. 6A-6C, according to one or more embodiments.

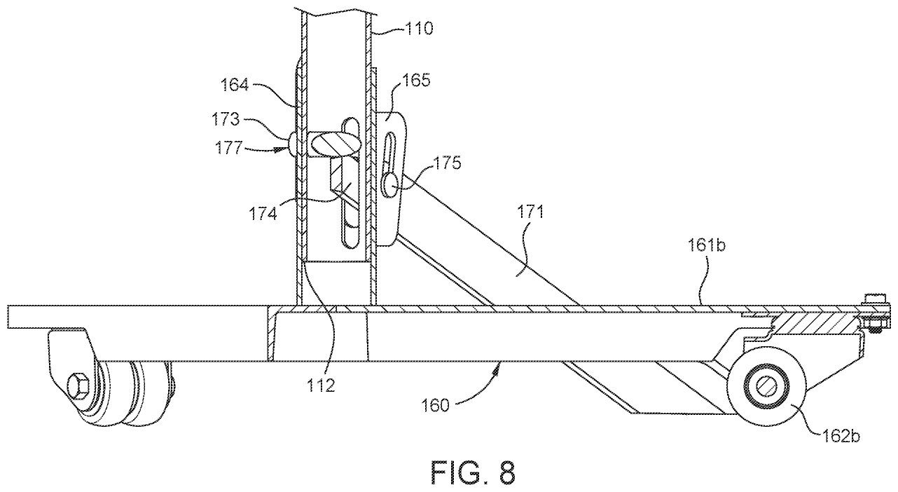

FIG. 8 is a schematic enlarged cross sectional view of a lower section of the side cross sectional view of the apparatus 100 shown in FIG. 5, according to one or more embodiments. As shown, the lever arm 171 is shown as actuated (e.g., pivoted) downwards, such as by a user pressing the user's foot on the foot platform 172. As the lever arm 171 is actuated downwards, the second fastener 175 travels downwards in slots formed in the flanges 165, and the first fastener 173 travels upwards in slots formed in the outer sleeve 164. Using the first fastener 173, the lever arm 171 is coupled to the shaft housing 110 at a linear position 177. As shown in FIG. 5 and FIG. 8, the linear position 177 is closer to a second end 112 of the shaft housing 110 than the first end 111 of the shaft housing 110. Movement (e.g., pivoting) of the lever arm causes the shaft housing 110 and the threaded shaft 120 to move linearly. In one or more embodiments, pivoting of the lever arm 171 downwardly drives the first fastener 173 upwardly using an end section 174 of the lever arm 171. For example, the lever arm 171 may pivot downwardly about the second fastener 175 to move the end section 174 upwardly, and the end section 174 moving upwardly drives the first fastener 173 upwardly and linearly moves the shaft housing 110 (which is coupled to the first fastener 173) linearly upwardly. The shaft housing 110 moving linearly upwardly moves the threaded shaft 120 linearly upwardly.

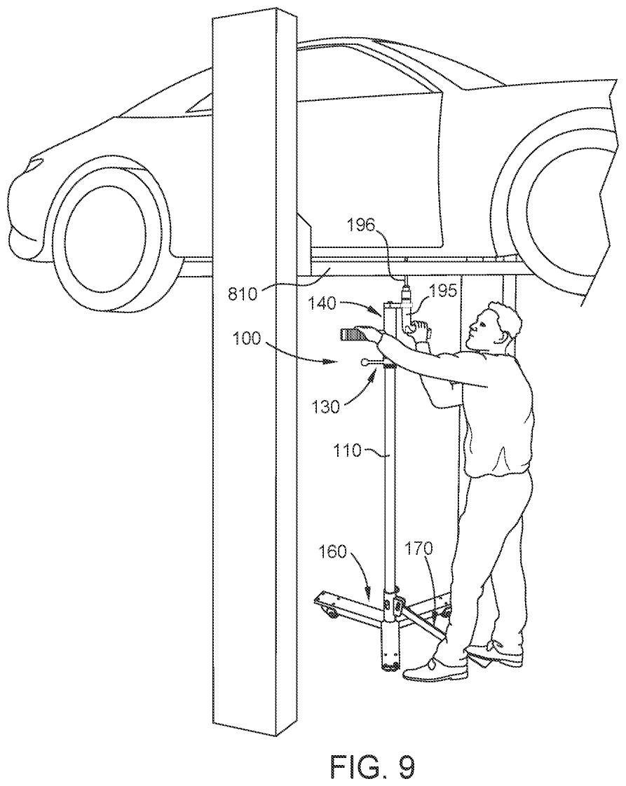

FIG. 9 is a schematic partial side view of a user operating the apparatus 100 to position the tool 195 in relation to a vehicle (e.g., vehicle frame 810), according to one or more embodiments. As shown, a user (such as operations personnel) may move the apparatus 100 supporting the tool 195 under the vehicle frame 810. The vehicle including the vehicle frame 810 is elevated off of the ground using a lift.

If a tool component (such as a drill bit 196) of the tool 195 is outside of a distance range relative to the vehicle frame 810, then a user can rotate the rotatable actuator 130 to raise the threaded shaft 120, the holder frame 140, and the supported tool 195 to position the tool component within the distance range. In one or more embodiments, the distance range is equal to or greater than a travel distance range by which the shaft housing 110 can linearly move upwardly upon pressing of the foot platform 172. The user can then push down on the foot platform 172 of the pivotable actuator 170 to pivot the lever arm 171 downwardly, which drives the threaded shaft 120 upwardly toward the vehicle frame 810. At substantially the same time, the user may power the tool 195 with one hand and hold the handle 145 rotationally in place with the other hand. By depressing the pivotable actuator 170, the user engages the tool component (e.g., the drill bit 196) with the vehicle frame 810 and drives the tool component (e.g., the drill bit 196) into the vehicle frame 810. For example, the tool component may be implemented to drill a hole in the vehicle frame 810. After the tool component contacts the vehicle frame 810, continued or additional force applied to the pivotable actuator 170 by the user will cause the holder frame 140 to compress the spring 150 due to the opposing force of the vehicle frame 810 on the tool component. Advantageously, compression of the spring 150 limits the magnitude of the force that is applied to the tool component (e.g., the drill bit 196) as a result of the user depressing the foot platform 172 of the pivotable actuator 170, thereby limiting wear and tear on the tool component (e.g., by reducing the incidence of drill bit 196 breakage).

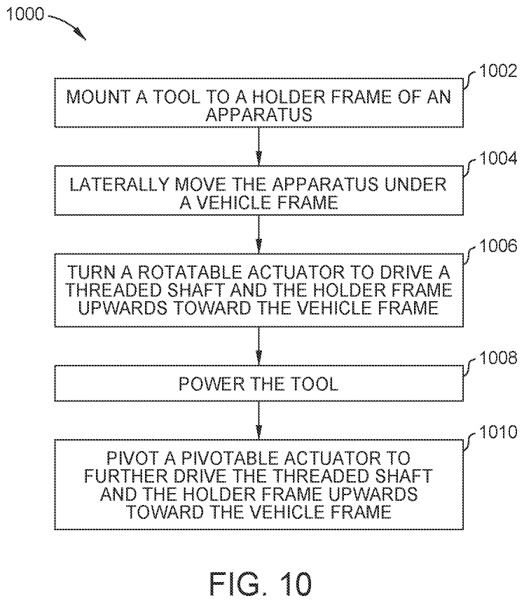

FIG. 10 is a flowchart of a method 1000 of positioning a tool in relation to a vehicle, according to one or more embodiments. The present disclosure contemplates that one or more operations (such as some or all) described herein (such as the operations described in relation to FIGS. 1-8) can be performed as part of the method 1000. Although the method 1000 is described in relation to the apparatus 100, the present disclosure contemplates that other apparatus may be used for the method 1000.

At operation 1002, the tool is mounted to the holder frame 140 of the apparatus 100. At operation 1004, the apparatus 100 is laterally moved under the vehicle. In one or more embodiments, the lateral moving of the apparatus 100 includes wheeling the holder frame 140, the shaft housing 110, and the threaded shaft 120 on the base frame 160 including the plurality of wheels 162a-162c.

At operation 1006, the rotatable actuator 130 is turned to drive the threaded shaft 120 and the holder frame 140 upwards toward the vehicle (e.g., vehicle frame 810). In one or more embodiments, the turning of the rotatable actuator 130 simultaneously moves the holder frame 140 and the threaded shaft 120, and the pivoting of the pivotable actuator 170 moves the threaded shaft 120 relative to the holder frame 140.

At operation 1008, the tool is optionally powered. The tool can be powered, for example, using electric power, pneumatic power, hydraulic power, and/or any other type of power.

At operation 1010, the pivotable actuator 170 is pivoted to further drive the threaded shaft 120 and the holder frame 140 upwards toward the vehicle. In one or more embodiments, the pivoting of the pivotable actuator causes the spring 150 positioned between the shaft housing 110 and the holder frame 140 to compress, biasing the holder frame 140 toward the vehicle. In one or more embodiments, the biasing of the holder frame 140 moves a tool component (e.g., drill bit 196) of the tool into the vehicle, for example, to drill an opening in the vehicle frame 810.

Benefits of the present disclosure include quick and accurate tool operation (e.g., drilling) from under a vehicle, reduced fatigue during tool operation (e.g., drilling) by operations personnel, reduced or eliminated chances of error during tool operation (e.g., drilling), simpler and inexpensive designs for vertical tool operations (e.g., drilling), and reduced wear and/or breakage of components (such as drill bits). Benefits also include modularity of application, such as across a variety of tool (e.g., pneumatic or electric tools, for example drills), and/or across a variety of vehicle frames (such as service vans (RSVs). As an example, operations personnel can drill a hole in a steel vehicle frame from below in 10 seconds or less, as compared to operations that can take 1-2 minutes to drill the hole without use of the apparatus 100. The drilled holes can be used, for example, to fasten an inverter to a steel beam of a vehicle frame in about 1-3 minutes, as opposed to about 12 or more minutes. As another example, a first holder frame that holds a first type of tool (such as a first type of drill) can be removed from an apparatus and replaced with a second holder frame that holds a second type of tool (such as a second type of drill).

It is contemplated that one or more aspects disclosed herein may be combined. As an example, one or more aspects, features, components, operations and/or properties of the embodiments of the apparatus 100, the stages of the apparatus 100 through operations shown in FIGS. 6A-6C and FIG. 8, the stages of the operations shown in FIG. 9, and/or the method 1000 may be combined. Moreover, it is contemplated that one or more aspects disclosed herein may include some or all of the aforementioned benefits.

While the foregoing is directed to embodiments of the present disclosure, other and further embodiments of the disclosure may be devised without departing from the basic scope thereof, and the scope thereof is determined by the claims that follow.

What is claimed is:

1. An apparatus for positioning a tool, comprising:
a shaft housing;
a threaded shaft extending into the shaft housing;
a rotatable actuator disposed about an outer section of the threaded shaft that is disposed outwardly of the shaft housing;
a holder frame disposed about the threaded shaft; and
a spring positioned between the rotatable actuator and the holder frame.

2. The apparatus of claim 1, further comprising an outer shoulder coupled to the threaded shaft and positioned between the spring and the rotatable actuator.

3. The apparatus of claim 2, wherein the spring abuts against the outer shoulder and against a washer, wherein the washer is positioned between the spring and a sleeve of the holder frame.

4. The apparatus of claim 1, wherein the holder frame comprises:
a sleeve;
a flange extending relative to the sleeve; and
one or more clamp arms coupled to the flange, wherein the one or more clamp arms are configured to couple to a drill.

5. The apparatus of claim 4, wherein the holder frame further comprises:
a handle extending relative to the sleeve; and
a fastener extending through the flange and coupled to the threaded shaft.

6. The apparatus of claim 4, further comprising a non-metallic sleeve disposed within the sleeve of the holder frame and positioned between the sleeve and the threaded shaft.

7. The apparatus of claim 1, wherein the rotatable actuator comprises:
a ring section encircling the threaded shaft; and
at least one arm extending outwardly relative to the ring section.

8. The apparatus of claim 1, further comprising a base frame, wherein the shaft housing is mounted to the base frame, and the base frame comprises a plurality of base arms supported by a plurality of wheels.

9. An apparatus for positioning a tool, comprising:
a shaft housing;
a threaded shaft extending into the shaft housing;
a rotatable actuator disposed about an outer section of the threaded shaft that is disposed outwardly of the shaft housing, wherein the threaded shaft is threaded into the rotatable actuator;
a holder frame disposed about the threaded shaft; and
a pivotable actuator coupled to the shaft housing.

10. The apparatus of claim 9, further comprising a spring positioned between the rotatable actuator and a sleeve of the holder frame.

11. The apparatus of claim 10, wherein the rotatable actuator comprises:
a ring section encircling the threaded shaft; and
at least one arm extending outwardly relative to the ring section.

12. The apparatus of claim 10, further comprising an outer shoulder coupled to the threaded shaft and positioned between the spring and the rotatable actuator, wherein the spring abuts against the outer shoulder and against a washer, wherein the washer is positioned between the spring and the sleeve of the holder frame.

13. The apparatus of claim 9, wherein the rotatable actuator comprises:
a ring section encircling the threaded shaft; and
at least one arm extending outwardly relative to the ring section.

14. The apparatus of claim 9, further comprising a bearing positioned between the rotatable actuator and a first end of the shaft housing.

15. The apparatus of claim 14, wherein the pivotable actuator comprises a lever arm that is coupled to the shaft housing at a linear position, and the linear position is closer to a second end of the shaft housing than the first end of the shaft housing.

16. The apparatus of claim 15, wherein movement of the lever arm causes the threaded shaft to move linearly.

17. A method of positioning a tool in relation to a vehicle, comprising:
mounting the tool to a holder frame of an apparatus;
laterally moving the apparatus under the vehicle, the apparatus further comprising:
a shaft housing, and
a threaded shaft extending into the shaft housing, wherein the holder frame is disposed about the threaded shaft;
turning a rotatable actuator disposed about the threaded shaft to drive the threaded shaft and the holder frame upwards toward the vehicle;
powering the tool; and
pivoting a pivotable actuator to drive the threaded shaft and the holder frame upwards toward the vehicle.

18. The method of claim 17, wherein the pivoting of the pivotable actuator comprises:
compressing a spring positioned between the shaft housing and the holder frame; and
biasing the holder frame toward the vehicle via the compressed spring, wherein the biasing of the holder frame moves a drill bit of the tool into the vehicle to drill an opening in a frame of the vehicle.

19. The method of claim 17, wherein laterally moving the apparatus comprises wheeling the holder frame, the shaft housing, and the threaded shaft on a base frame comprising a plurality of wheels.

20. The method of claim 17, wherein turning the rotatable actuator simultaneously moves the holder frame and the threaded shaft, and pivoting the pivotable actuator moves the threaded shaft relative to the holder frame.
